(19) United States
(12) Patent Application Publication
(10) Pub. No.: US 2017/0289465 A1
(43) Pub. Date: Oct. 5, 2017

(54) MULTISPECTRAL EYEWEAR DEVICE

(71) Applicant: NIKON RESEARCH CORPORATION OF AMERICA, Belmont, CA (US)

(72) Inventor: Steven Douglas Slonaker, San Mateo, CA (US)

(21) Appl. No.: 15/470,623

(22) Filed: Mar. 27, 2017

Related U.S. Application Data
(60) Provisional application No. 62/314,723, filed on Mar. 29, 2016.

(51) Int. Cl. H04N 5/33; H04N 5/247; H04N 5/232; G06T 5/00; G06T 5/50

(52) U.S. Cl. CPC H04N 5/332; G06T 5/006; G06T 5/50; H04N 5/23293; H04N 5/247; G06T 2207/10048; G06T 2207/20221

(57) ABSTRACT

A problem of automatic co-registration of multiple images, of the same scene, acquired through multispectral imaging channel(s) (including but not limited to IR, NIR, visible light channels) and polarized imaging in real time is solved by combining into a single eyewear device imaging cameras each configured to acquire imaging through a specific channel. Images from all cameras are simultaneously processed in real-time to deliver overlapping (and accurately registered) composite images, which are displayed to a viewing screen on the inside of the eyewear device.

### CROSS-REFERENCE TO RELATED APPLICATIONS

The present application claims priority from the U.S. Provisional Patent Application No. 62/314,723, filed on Mar. 29, 2016 and titled “Multispectral Eyewear Device”, the disclosure of which is incorporated herein by reference.

### TECHNICAL FIELD

The present invention relates to multispectral imaging and, more particularly, to methodologies of forming images in infra-red portion of the spectrum and associated polarization transformation techniques.

### BACKGROUND

Through the years, development of technology for use in IR or near-IR (NIR) imaging, multispectral (polyspectral) imaging and/or polarization imaging have been following related but, at the same time, highly specialized paths. Specifically, in each of these imaging methodologies, the technology required to implement a working piece of hardware remained (and remains) highly specialized, often unique and/or very expensive.

Among applications of imaging devices operating according to the above-mentioned modalities there are:
In case of multispectral imaging: a) Remote sensing of vegetation, water; b) Surface color, texture, shape, size, and chemical composition; c) Identification of defects and foreign matter in a chosen sample;
In case of NIR or IR imaging (including low-resolution imaging): a) Imaging of engines, heating/cooling applications (IR); b) Determination of film thickness, characterization of optical coatings (NIR); c) Medial applications such as, for example, determination of blood flow through vessels, characterization of brain tissue (for example, non-invasive optical imaging for measuring pulse and arterial elasticity in the brain; NIR);
In case of polarization imaging: a) Photo-elastic stress monitoring (e.g. glass/plastic molding inspection); b) Window and Display (e.g. TVs, monitors) manufacturing and polish; c) Medical imaging of organs/vessels/tissue, highlighting stress and strain.

Very specialized demands are partly responsible for the fact that development along different of these separate development paths has proceeded independently from the development along a related path, with no significant effort to combine the technologies. The remaining and to-date not addressed technological need includes the reduction in the size and cost of the key components associated with each of these separate imaging tools, as well as advances in the design and manufacture (and reduced costs) of micro-optical elements, enables it now to (appear to) be feasible to consolidate such a comprehensive range of image types into a single device.

The present invention addresses the need to simplify an approach that requires the use of multiple measuring/imaging methodologies by coordination of features of different modalities in a non-mutually-exclusive way to a multi-spectral-polarizing imaging device and viewer, a contraption uniquely characterized by various features as discussed below.

### SUMMARY

Embodiments of the invention provide an eyewear device that includes a face portion containing a frame and a shield portion carried by the frame, the face portion dimensioned to position the shield portion against eyes of the user when affixed to user's head, wherein the shield portion has a thickness limited by front and back surfaces of the shield portion, the back surface facing the eye during operation of the device. The device also includes a display integrated with the back surface and programmable electronic circuitry disposed in the face portion. The device additionally includes a first array of operably independent optical imaging systems each having a respectively-corresponding optical detector in electrical communication with the programmable electronic circuitry, each of said independent optical systems positioned in cooperation with the front surface and through the face portion such as to capture light incident on the front surface and to form a corresponding image at a respectively-corresponding optical detector. The programmable electronic circuitry is configured to calibrate image distortion of images formed at optical detectors to form undistorted images and co-register signals representing the undistorted images at the display to form a single aggregate image in which the data representing undistorted images is weighed in response to a user input to the electronic circuitry.

### BRIEF DESCRIPTION OF THE DRAWINGS

FIG. 1 schematically illustrates an implementation of the device of the invention. Multiple camera arrays are available for producing stereoscopic images.

FIG. 2 provides flow-chart illustrating image capture and flow of processing of acquired optical image information.

FIG. 3 summarizes operational characteristics of a specified optical sensor used in a related embodiment of the invention.

### DETAILED DESCRIPTION

Object detection and identification in complex environments requires exploitation of multiple discriminants, to fully distinguish between objects of interest and surrounding clutter. For passive surveillance applications, for example, multispectral, hyperspectral, and polarization imaging modalities have each shown some capability for object discrimination. Polarization provides, in particular, a powerful discriminator between natural and man-made objects. An unpolarized view typically fails to accentuate artificially created features that appear extremely bright in a polarized view. Simple estimates, however, indicate that use of either spectral or polarization technique alone, by itself, suffers a very distinctly limiting operational discrimination. For example, as would be recognized by a skilled artisan, polarization properties may be wavelength dependent. Thus, neither measurement of spectral properties nor of polarization properties alone can completely characterize the optical signature.

At least in part, the disadvantages of the existing imaging systems are caused by large sizes and weights of currently known independent spectral and polarization packages. The high weight and size figures are only exacerbated by the fact that both weight and bulk must be aggregated to obtain several of these capabilities together, in operable coordination in one instrument. (Typically the modern observational packages occupy more than 65 in³ and add a payload of five or six pounds, each. As these units are not designed to fit together, the effective aggregate volume may typically come to over 80 in³). In the commercial/medical context, analogously, the development of spectral and polarization equipment separately has kept overall costs for the two capabilities somewhat in excess of $50,000. As a consequence these devices, paired, are not generally to be found in medical diagnostics—even though they have been demonstrated as an effective diagnostic tool for early detection of skin cancer (melanoma). Likewise these devices are not significantly exploited for industrial process control (finish inspection and corrosion control), or land-use management (agriculture, forestry, and mineral exploration).

Much more severe, however, than the above-discussed system volume, weight and cost burdens are key technical limitations that actually obstruct both high resolution and high signal-to-noise in overall discrimination of objects of interest against complicated backgrounds. Multispectral and multipolarization data provide complementary measurements of visual attributes of a scene, but when acquired separately these data are not inherently correlated—either in space or in time.

Embodiments of the invention address a need in an imaging eyewear device co-registering optical data acquired with the simultaneous use of multi-spectral and polarization-based image acquisition for a direct unimpeded delivery to the visual system of the device-wearer.

A problem of automatic co-registration of multiple images, of the same scene, acquired through multispectral imaging channel(s) (including but not limited to IR, NIR, visible light channels) and polarized imaging in real time is solved by combining into a single eyewear device imaging cameras each configured to acquire imaging through a specific channel. Images from all cameras are simultaneously processed in real-time to deliver overlapping (and accurately registered) composite images, that are displayed to a viewing screen on the inside of the eyewear device.

Main features of the embodiment(s) include:
1) Simultaneous acquisition of optical data through one of the “channels”: IR and/or NIR imaging channels, Multiple pre-determined filtered spectra within the visible wavelength band; Polarization imaging channel; and Standard ‘Full Visible’ wavelength band.
2) Computer Processing of each of the above-identified acquired imaging data set to resize each resulting image independently from another; facilitate edge detection of primary subjects in the respectively-corresponding camera's field-of-view (FOV); identification/cropping down of pre-defined images to remove the exclude overlapping FOVs; Registration/overlay of all image types onto a single grid.
3) Image acquisition and viewing configured as either a fixed ‘snapshot’ in time (producing a photo- or still image, thereby allowing for fine-tuning of exposure and post-processing parameters for each separate image type) or/and a “real time” process (producing sequence of video frames at predetermined rates for sequential display on the inner-display of the eyewear device or a remote screen). For the purposes of this disclosure and accompanying claims, a real-time performance of a system is understood as performance which is subject to operational deadlines from a given event to a system's response to that event. For example, a real-time extraction of optical/imaging information (such as irradiance within a pre-defined spectral band, for example, or a state of polarization of light forming a particular image) from light acquired with the use of image-acquisition optical system may be one triggered by the user and executed simultaneously with and without interruption of image acquisition during which such information has been determined.
4) User-selectable mixing and overlapping of image types
   all image types always being acquired, user selects ‘most informative mix’
5) Initial implementation: Image viewing via goggles
   Image can be sent to another parallel (or single) display at any time
   First implementation would be ‘single-image’ (‘monoscopic’)
   Stereoscopic version would be developed in parallel, enabled in first hardware implementation

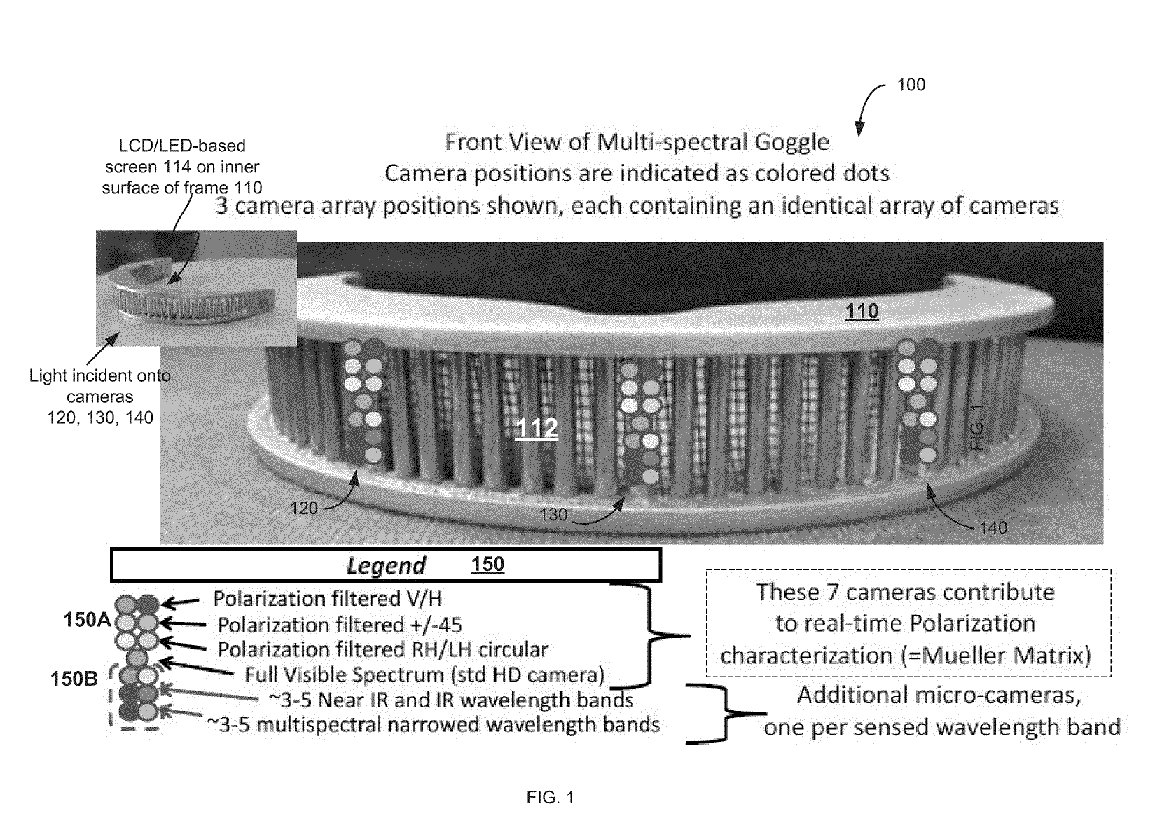

In reference to FIG. 1, for example, the embodiment 100 of an eyewear device, structured according to the idea of the invention, includes a framework/frame 110. While a solid, one-piece frame 110 is shown, an embodiment 100 in general may contain a central portion of a frame (the lower portion of which has a bridge dimensioned to accommodate a user's nose) to which, on each side, an optionally-adjustable in lengths arches (or temples) are attached. Such frame/arms may be complemented by side and/or top shield (not shown) dimensioned to block ambient light from penetrating towards the nose of the user while the device is being worn/juxtaposed against the face of the user.

According to the idea of the invention, an array of imaging micro-cameras (collectively shown as three groups of cameras 120, 130, 140) each of which is specifically configured to acquire optical information according to one of channels identified above, into the outer framework 110 of an eyewear device 100, referred to for simplicity herein as goggles. The inside of the goggle framework 110 is structured to incorporate an LCD/LED screen 114 (not shown) which is a substantially light-tight environment when the wearer puts the framework 110 on (that is, optically sealed from the ambient medium surrounding the wearer of the goggles 100 such that substantially no light penetrates from outside the periphery of the goggles) at a pre-determined and fixed distance from the wearer' eyes.

Legend 150 provides examples of filtering systems with which individual cameras from at least one of the sets 120, 130, 140 can be equipped. The filtering systems or filters, for short, include polarization filters 150A (for example, optical polarizers operating in transmission to deliver linearly-polarized light towards the optical detector of a particular camera; polarizers transmitting light having elliptical polarization) as well as specific spectral filters 150B the bass-band characteristics of which is adjusted to match the desired spectral bands of sensitivity of cameras equipped with such filters. The operational characteristics of the polarization filters 150A and a spectral filter providing the “full visible spectrum” operation of one of the cameras in the set (as shown in legend 150) are judiciously chosen to ensure that optical data acquired with these cameras is operationally complete to effectuate data-processing based on Mueller calculus (that is, based on manipulating Stokes vectors representing the polarization of light delivered by these seven cameras to the corresponding optical detectors) or, more generally, based on Jones matrix calculation.

Content of the aggregate image presented to the user's visual system by the screen 114 can be manipulated by the user in terms of which mix of images received from the cameras of sets 120, 130, 140 forms such aggregate image. For example, when the device 110 is employed in automotive application—in a given automobile factory ‘panel-installation-and-inspection’ task, as one example—a combination of image(s) from cameras(s) acquiring optical information at IR wavelengths along with those received at the visible wavelengths and images formed in p-polarized light may provide the best desired feedback to the line technician, highlighting both temperature and stress distributions that are present in a sample/part under test. In that case, the technician would select that appropriate ‘mix’ of inputs to make up the image being viewed through the device 110.

The design illustrated in FIG. 1 facilitates the applications of the device under conditions when either a monoscopic or stereoscopic image capture and/or display are required.

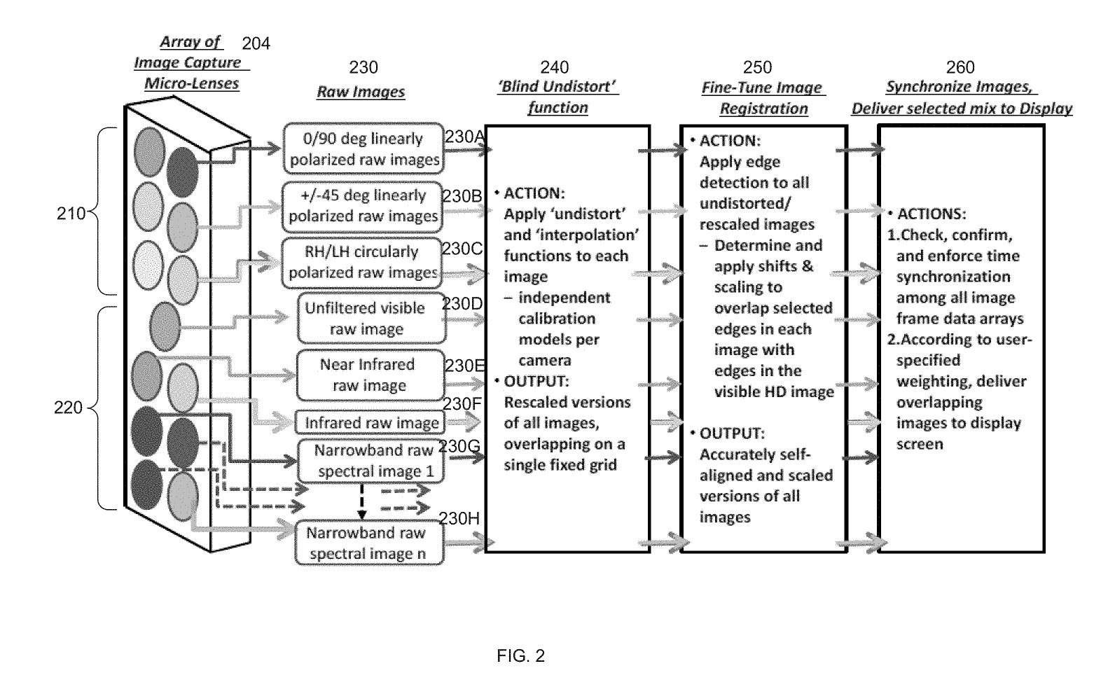

Example of the flow of the operation, image processing, and display of the optical information acquired with the device 100 is shown schematically in FIG. 2. Here a single set of cameras (shown as an array 204) such as the set 120, 130, 140 of FIG. 1 is shown to include a group 210 of cameras (corresponding to the sub-set 150A of FIG. 1) and a group 220 of cameras (corresponding to the subset 150B of FIG. 1). It is noted that multiple optical detection units (cameras) 150A, 150B, 210, 220 represent only symbolically the various ‘modes of detection capability’ vs. forcing each one of them to be ‘independent detectors’. In practical implementation, detection within one or more of these different ‘spectral bands’ represented by multiple cameras could be achieved with a single ‘camera’ (with a single detector chip the various pixels of which are separately filtered into various desired bands). Even more practical realistic implementation of the eyewear device of the invention may utilize only one or two detector chips per angle (where three camera viewing angles are used in the current design) to capture all signals at the wavelengths of interest.

Each of the independently operating optical cameras in the array 204 (some of which is equipped with a respectively-corresponding filter system, as discussed in reference to FIG. 1) gathers optical information in a respectively-corresponding spectral band (which optionally, under specific circumstances, may partially overlap with a spectral band of transmission of another camera in the array). As a result, the array 204 provides for simultaneous acquisition of images 230 (either still images or real-time sequence of images) along the channels the number of which is equal to the number of cameras in the set.

Following capture of the raw images 230 by the corresponding cameras (and appropriate application of gain control and noise filtering of each image independently, as controlled by a computer processor), each image channel has a fixed ‘calibration’ image distortion, and a compensation transformation function is applied to the raw image data, 240. This corresponds to a fixed amount of magnification, distortion, and registration offset between and among the different camera images 230A, 230B, 230C, 230D, 230E, 230F, 230G, and 230H. The transformation function that is applied to each separate camera image is determined during a dedicated “calibration measurement sequence”.

The following application of the calibrated ‘undistort/interpolate/register function’ at step 250 results in an aligned set of images from all cameras. A separate “fine alignment” step 260 may be additionally performed among/between the images formed at step 250. The fine alignment includes first applying an edge-detection algorithm to each scene independently, followed by the calculation the optimum rescaling and offsets necessary (per image) to best-fit the considered edges from all images coincidentally on top of the visible-wavelength HD image (as the reference). Once the various image data have all been aligned, the user-selected combination of images and weighting are mixed and delivered, at step 260, to the display screen (in the goggles and/or remotely connected) to form an aggregate image in which each of the individual constituent images not only occupy the single and only FOV but are also synchronized in space and time.

Governing of data-acquisition and processing is effectuated with programmable electronic circuitry preferably within the frame 110 or within the screen portion 112 of the eyewear device. The circuitry includes a processor controlled by instructions stored in a memory, which can be random access memory (RAM), read-only memory (ROM), flash memory or any other memory, or combination thereof, suitable for storing control software or other instructions and data or information conveyed to the processor through communication media, including wired or wireless computer networks. In addition, while the invention may be embodied in software, the functions necessary to implement the invention may optionally or alternatively be embodied in part or in whole using firmware and/or hardware components, such as combinatorial logic, Application Specific Integrated Circuits (ASICs), Field-Programmable Gate Arrays (FPGAs) or other hardware or some combination of hardware, software and/or firmware components.

It is appreciated that, while in one embodiment, each of the individual cameras of the array 204 may be equipped with a respectively-corresponding optical detector, in a related embodiment the temporal and spatial registration of multiple images acquired along different channels can be effectuated with the use of a single camera—instead of the array 204—which camera is configured to simultaneously in a single act of exposure acquire multiple images that are both multispectral and multipolarizational and provide, from a single optical detector chip such images. In this implementation, all spectral and polarization image planes are automatically and inherently co-registered resulting in no registration error.

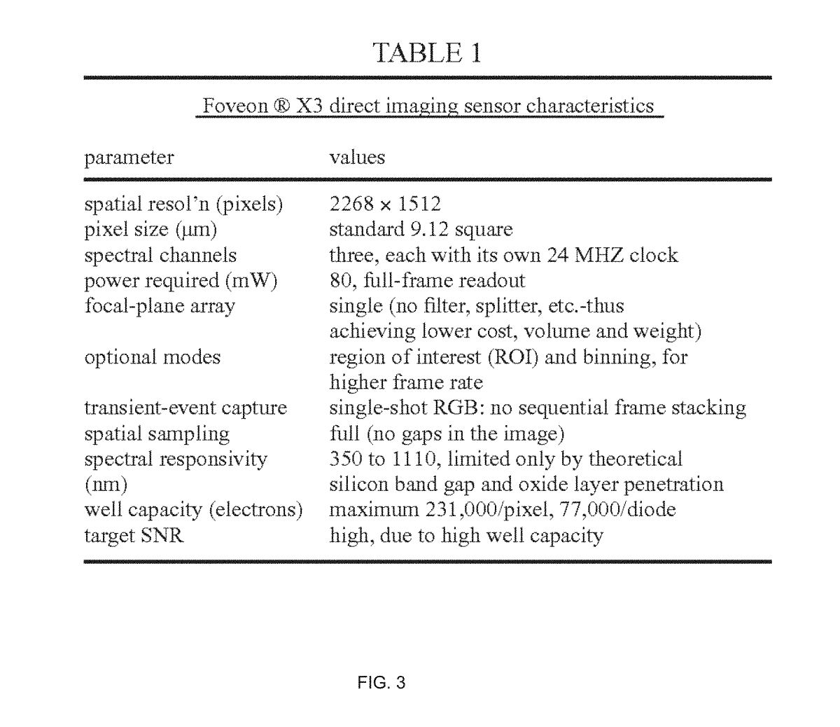

In such related embodiment (not shown), a Foveon X3 single-chip direct imaging sensor can be employed (see description of this sensor at www.foveon.com or in US 2009/0021598, the disclosure of which is incorporated by reference herein), FIG. 3. This CMOS device provides high resolution (10 megapixels: 2268 by 1512 by 3 bands), large dynamic range (12 bits), and wide spectral bandwidth (350 to 1110 nm). A multispectral camera system employing such sensor completely eliminates the spatial registration and aliasing problems encountered with more-familiar multi CCD and Bayer-type color cameras.

In accordance with examples of embodiments, an eye-worn device has been discussed containing an optical imaging system that is configured to simultaneously acquire optical information in multiple multispectral and/or multipolarizational channels. While specific values chosen for these embodiments are recited, it is to be understood that, within the scope of the invention, the values of all of parameters may vary over wide ranges to suit different applications.

Disclosed aspects, or portions of these aspects, may be combined in ways not listed above. Accordingly, the invention should not be viewed as being limited to the disclosed embodiment(s).

What is claimed is:

1. An eyewear device comprising:
a face portion of the device including a frame and a shield portion carried by the frame, the face portion dimensioned to position said shield portion against eyes of the user when affixed to the user's head,
wherein the shield portion has a thickness limited by front and back surfaces of the shield portion, the back surface facing the eye during operation of the device;
an display integrated with the back surface;
programmable electronic circuitry in said face portion; and
an first array of operably independent optical imaging systems each having a respectively-corresponding optical detector in electrical communication with the programmable electronic circuitry, each of said independent optical systems positioned in cooperation with the front surface and through the face portion such as to capture light incident on the front surface and to form a corresponding image at a respectively-corresponding optical detector;
said programmable electronic circuitry configured to calibrate image distortion of images formed at optical detectors to form undistorted images and co-register signals representing the undistorted images to said display to form a single aggregate image in which the data representing undistorted images is weighed in response to a user input to said electronic circuitry.

2. An eyewear device according to claim 1, wherein a plurality of independent optical imaging systems in said array includes first individual optical channels each equipped with a corresponding filter defining a polarization vector of light propagating through said optical channels, wherein aggregately such filters of the first individual optical channels determine a set of operational characteristics that enables optical data processing, by said electronic circuitry, according to a Jones matrix methodology.

3. An eyewear device according to claim 2, wherein there are seven first individual optical channels and wherein said plurality further comprises a plurality of second optical channels having corresponding transmission bands in IR portions of optical spectrum.

4. An eyewear device according to claim 2, wherein said plurality further comprises a plurality of third optical channels having corresponding multispectral transmission bands.
